(19) United States
(12) Patent Application Publication
(10) Pub. No.: US 2002/0097742 A1
(43) Pub. Date: Jul. 25, 2002

(54) Methods and apparatus for multimedia broadband telecommunication

(75) Inventor: Y. Brian Chen, Flemington, NJ (US)

Correspondence Address: David P. Gordon, Esq., 65 Woods End Road, Stamford, CT, 06905, US

(73) Assignee: ViaGate Technologies, Inc.

(21) Appl. No.: 09/767,016

(22) Filed: Jan. 22, 2001

(51) Int. Cl. H04J 3/16; H04L 12/66

(52) U.S. Cl. 370/463; 370/465

(57) ABSTRACT

Methods for broadband multimedia telecommunication include broadcasting a large selection of video streams via fiber optic to local switches which are coupled to customers by POTS lines and providing video streams, high QOS voice and VDSL data service from the local switch to customer premises. Signals from customer premises equipment communicate to the local switch to select up to four simultaneous video streams (out of hundreds available). According to the presently preferred embodiment, video, data, and digital voice service are provided via ATM cells to the local switch where they are multiplexed with lifeline POTS service and transmitted to the customer premises via ATM cells Multicast video streams are duplicated at the point in the switch closest to the customer.

### BACKGROUND OF THE INVENTION

1. Field of the Invention

The invention relates to telecommunications. More particularly, the invention relates to a broadband telecommunication systems for voice, video, and data.

2. State of the Art

One of the latest developments in telecommunications is broadband telecommunications in the home. Presently, many homes have had access to a wide variety of video via cable TV, access to voice communications by POTS (plain old telephone service) and access to the internet via a modem of some type. Until recently, the fastest internet connection available to most homes was the v.90 modem which uses POTS to achieve a downlink bandwidth of up to 53K and an uplink bandwidth of up to 33.6K.

Recently two types of broadband services have become available for the home and small business. These are the “cable modem” and various types of DSL (digital subscriber line) services. Cable modems utilize the existing cable TV network to provide high speed internet access at rates twenty to forty times that of a v.90 modem. DSL service involves various different standards whereby relatively high data rates are provided over existing POTS lines. It will be appreciated that cable modem service is available through cable TV companies and DSL service is available though telephone service providers. Thus, cable TV companies compete with telephone service providers for high speed internet access customers.

Changes in FCC regulations now permit cable TV companies to provide telephone service and permit telephone companies to provide cable TV-type service. Providing telephone services via a cable TV network and providing television programming via existing POTS lines each has different challenges which must be surmounted. Although the coaxial cable used by cable TV has a much higher maximum bandwidth (up to 4 gigahertz) than the copper wire known as “twisted pair” used by telephone companies, it is shared bandwidth. Shared bandwidth is perfectly well suited for unidirectional broadcast of television signals to many customers but is not well suited to bidirectional transmission of multiple voice and/or data streams. On the other hand, an unshielded twisted pair, which can provide 20-30 megahertz bandwidth for up to 3,000 feet, is more than adequate for bidirectional transmission of a single voice and/or data stream, but is inadequate for providing the hundreds of unidirectional video streams which are available from cable TV companies. Thus, while cable TV companies are challenged with maintaining quality of service (QOS) when offering telephone and bidirectional data services, telephone companies are challenged with providing a broad selection of video streams when offering video viewing services.

One solution to the challenge of offering both television and telephone service is for one company to control both the twisted pair and the coaxial cable for each customer. This solution overcomes the disadvantages of telephone service via shared coaxial cable and television service via relatively low bandwidth POTS lines. However, this solution is not truly an integrated solution and is costly to implement as it requires telephone companies to install coaxial cable for each customer and it requires cable television companies to install POTS lines for each customer. In both cases, companies are forced to work in areas in which they have no expertise.

### SUMMARY OF THE INVENTION

It is therefore an object of the invention to provide methods and apparatus for broadband multimedia telecommunication.

It is also an object of the invention to provide methods and apparatus for broadband multimedia telecommunication which includes combined voice, video, and data communications.

It is another object of the invention to provide methods and apparatus for broadband multimedia telecommunication which maintains high QOS for voice and data while offering a large selection of different video streams.

It is a further object of the invention to provide methods and apparatus for broadband multimedia telecommunication which are cost effective.

It is an additional object of the invention to provide telephone companies with a single and straightforward system for competing with cable television companies in the integrated voice-video-data telecommunications market.

In accord with these objects which will be discussed in detail below, the methods of the present invention include broadcasting a large selection of video streams via fiber optic cables over an ATM network to local switches. The local switches are coupled to customers by POTS lines and provide a predetermined number of (e.g. up to four) simultaneous video streams together with high QOS voice and VDSL data service from the nearest local switch to each customer premises device. According to the methods of the invention, at each customer premises, the predetermined number of simultaneous video streams (out of hundreds available) are selected by signals from customer premises equipment to the local switch which transmits that number of different video streams from the local switch to the customer premises. According to the presently preferred embodiment, video, data, and digital voice service are provided via ATM (asynchronous transfer mode) cells from the network to the local switch where they are multiplexed with lifeline POTS service and transmitted to the customer premises via ATM cells.

The presently preferred hardware of the invention utilizes CellBus® technology from TranSwitch Corporation, Shelton, Conn. According to the presently preferred embodiment, the local switches each have four CellBus® backplanes supporting up to three OC-12 (or twelve OC-3) network connections with one backplane being redundant. Each local switch supports up to ten VDSL line cards, each supporting up to sixteen VDSL lines. The maximum bandwidth of each local switch is approximately 2.5 gigahertz which supports one hundred sixty VDSL connections as well as up to two hundred twenty theater quality MPEG-2 video streams or up to 440 standard quality MPEG streams or a combination of standard and high quality streams. Customer premises equipment according to the invention include a high speed modem which couples a personal computer to the customer's POTS line, a residential gateway unit which supports up to six devices (computers, TVs, digital voice lines) in addition to the lifeline POTS service, and a set top box for coupling a conventional television to the customer's POTS line or to the residential gateway. According to the presently preferred embodiment, the set top box is provided with enhanced functionality for accessing the internet, selecting from among hundreds of video streams including broadcast video and video on demand, etc. In order to conserve bandwidth within each local switch, multicast video streams are duplicated at the point closest to the customer.

According to the invention, all broadcast video streams are delivered to the local switch for distribution as requested by customers. Unlike other digital video distribution systems, requests from customers for access to a particular video stream are not sent back to the video stream source, but are served by the local switch. According to a presently preferred method of the invention, when a customer requests a video stream, the request is sent to the VDSL line card which determines whether the selected stream is already being carried by that line card and duplicates the video stream at the line card if it is available. If the video stream is not available at the line card, the line card creates a new video stream through the line card to the customer who requested it.

Additional objects and advantages of the invention will become apparent to those skilled in the art upon reference to the detailed description taken in conjunction with the provided figures.

### BRIEF DESCRIPTION OF THE DRAWINGS

FIG. 1 is a high level schematic diagram of a broadband multimedia communication system according to the invention;

FIG. 2 is a high level block diagram illustrating the major components of a local switch according to the invention;

FIG. 3 is a high level block diagram illustrating the major components of a core switch module of the local switch of FIG. 2;

FIG. 4 is a high level block diagram illustrating the major components of a system controller card of the local switch of FIG. 2;

FIG. 5 is a high level block diagram illustrating the major components of a trunk (OC-3) interface card of the local switch of FIG. 2;

FIG. 6 is a high level block diagram illustrating the major components of a VDSL line cards of the local switch of FIG. 2;

FIG. 7a is a high level block diagram illustrating the major components of one type of customer premises equipment, i.e. a high speed internet interface;

FIG. 7b is a high level block diagram illustrating the major components of another type of customer premises equipment, i.e. a high speed internet interface with four derived (digital) voice-lines;

FIG. 7c is a high level block diagram illustrating the major components of a digital set top box for use in conjunction with the customer premises equipment shown in FIGS. 7a or 7b;

FIG. 8 is a screen shot illustrating the user interface of the software used to configure the local switch and customer premises equipment;

FIG. 9 is a schematic diagram illustrating how management information flows between the configuration software and a local switch;

FIG. 10 is a schematic diagram illustrating how management information flows between the configuration software and the customer premises equipment;

FIG. 11 is a schematic diagram illustrating how signalling and connection management information flows between the customer premises equipment and a service provider; and

FIG. 12 is a schematic diagram illustrating how signalling and connection management information flows between the local switch and the customer premises equipment with regard to video streams.

### DETAILED DESCRIPTION OF THE PREFERRED EMBODIMENTS

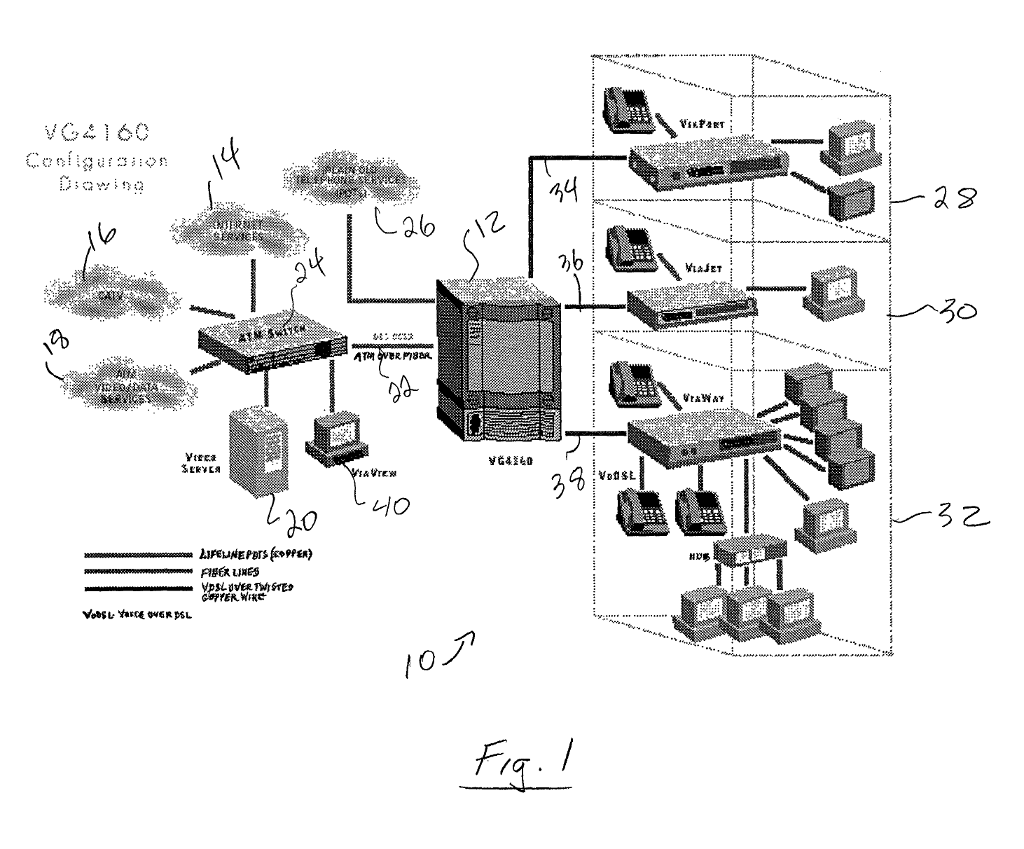

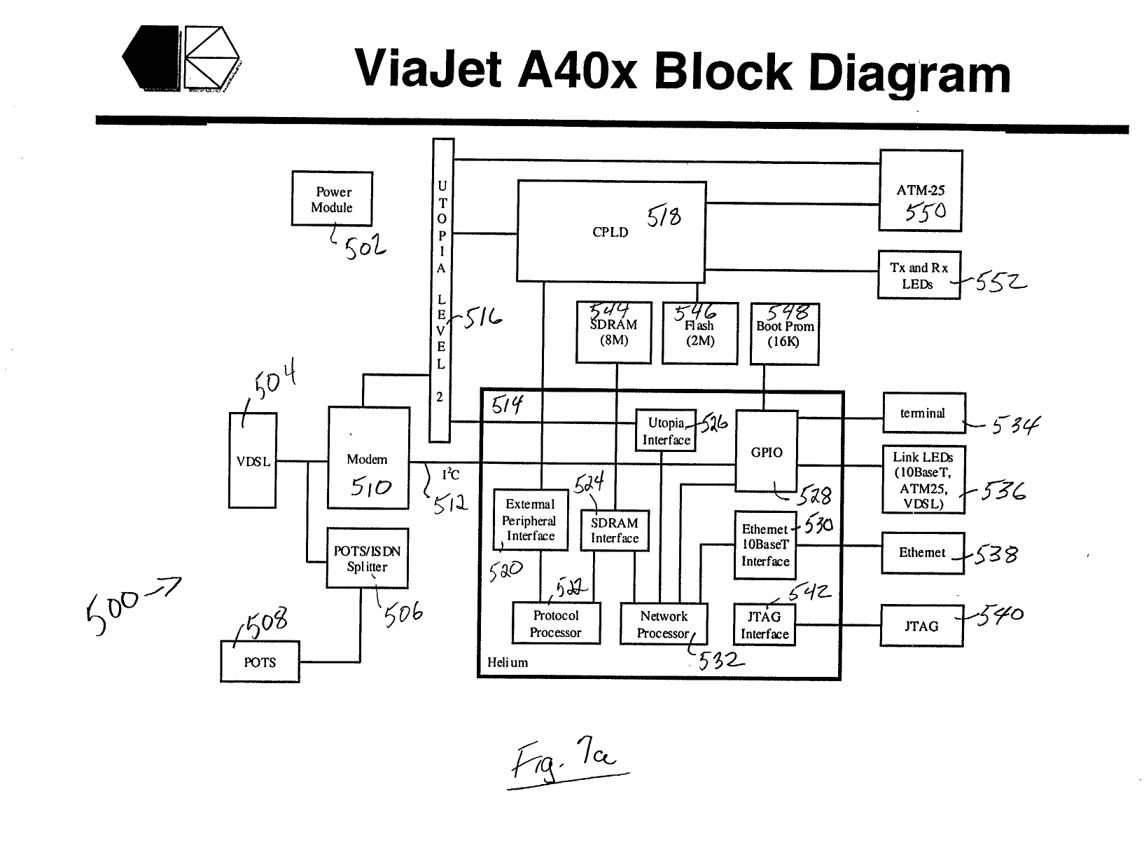

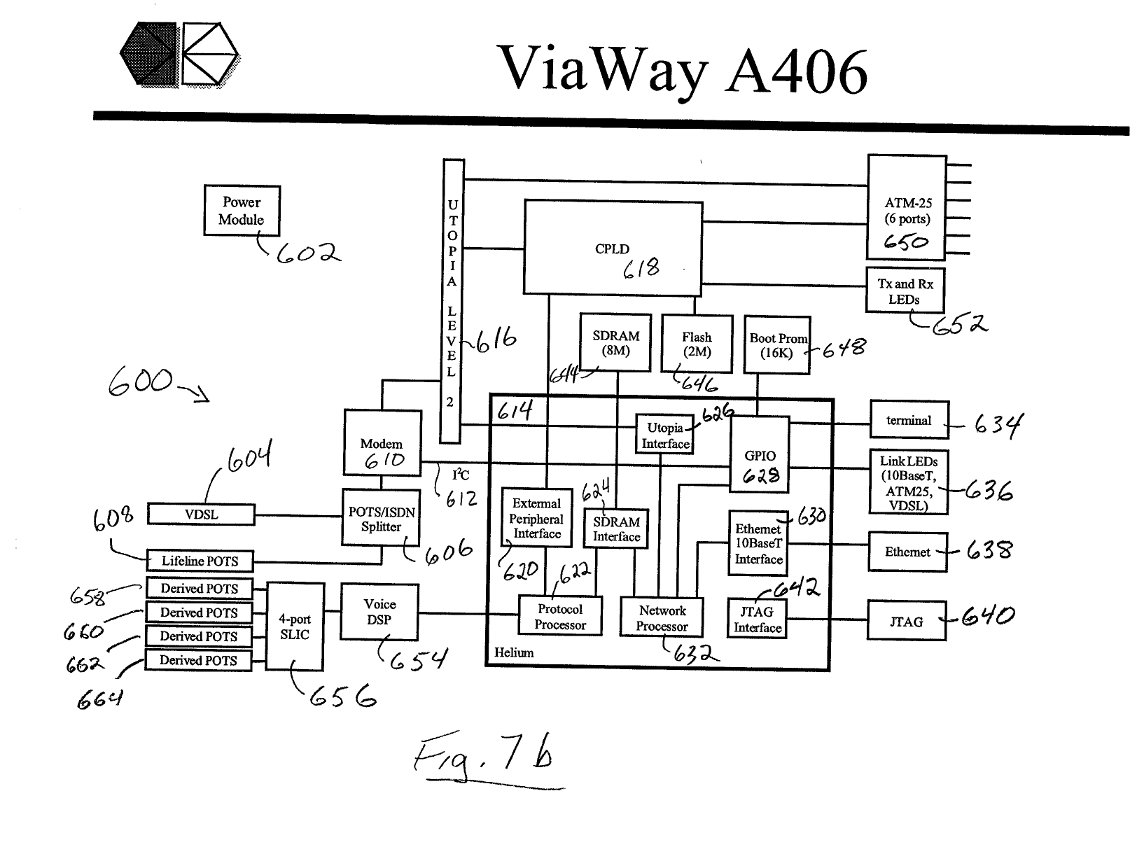

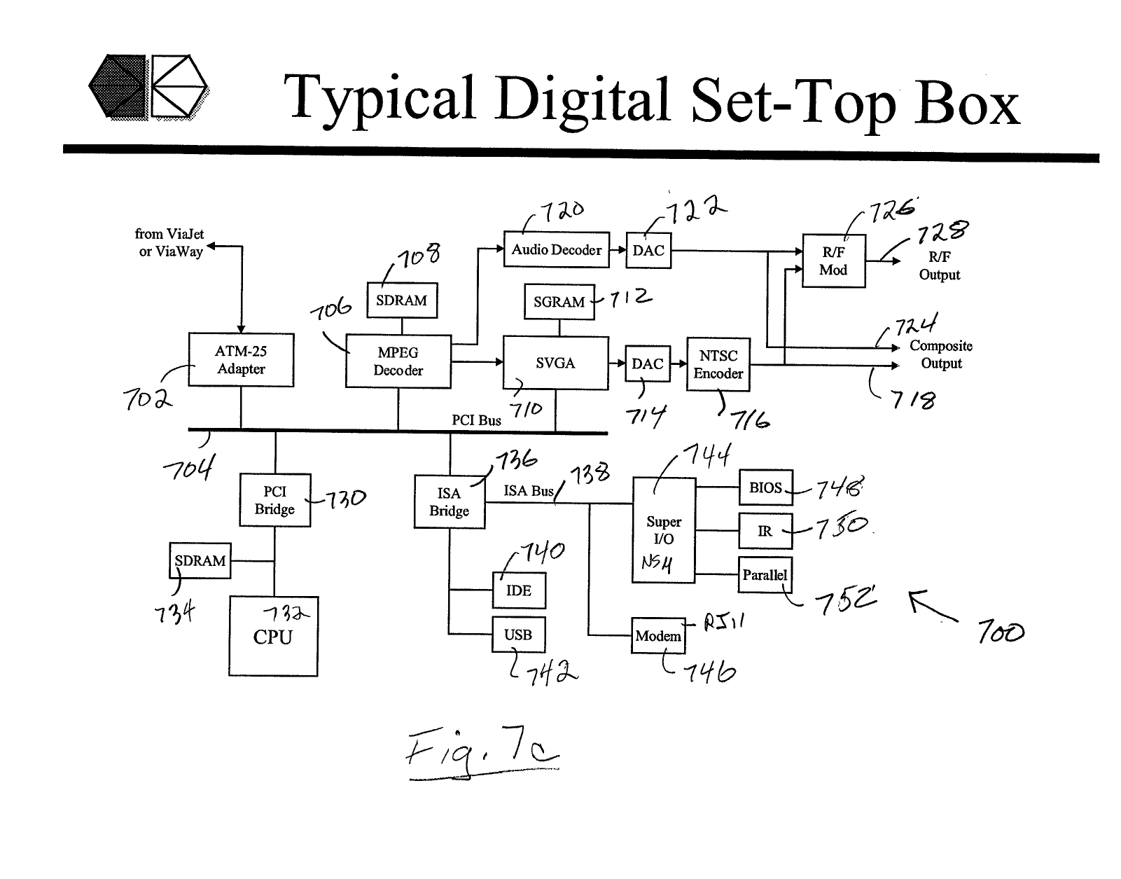

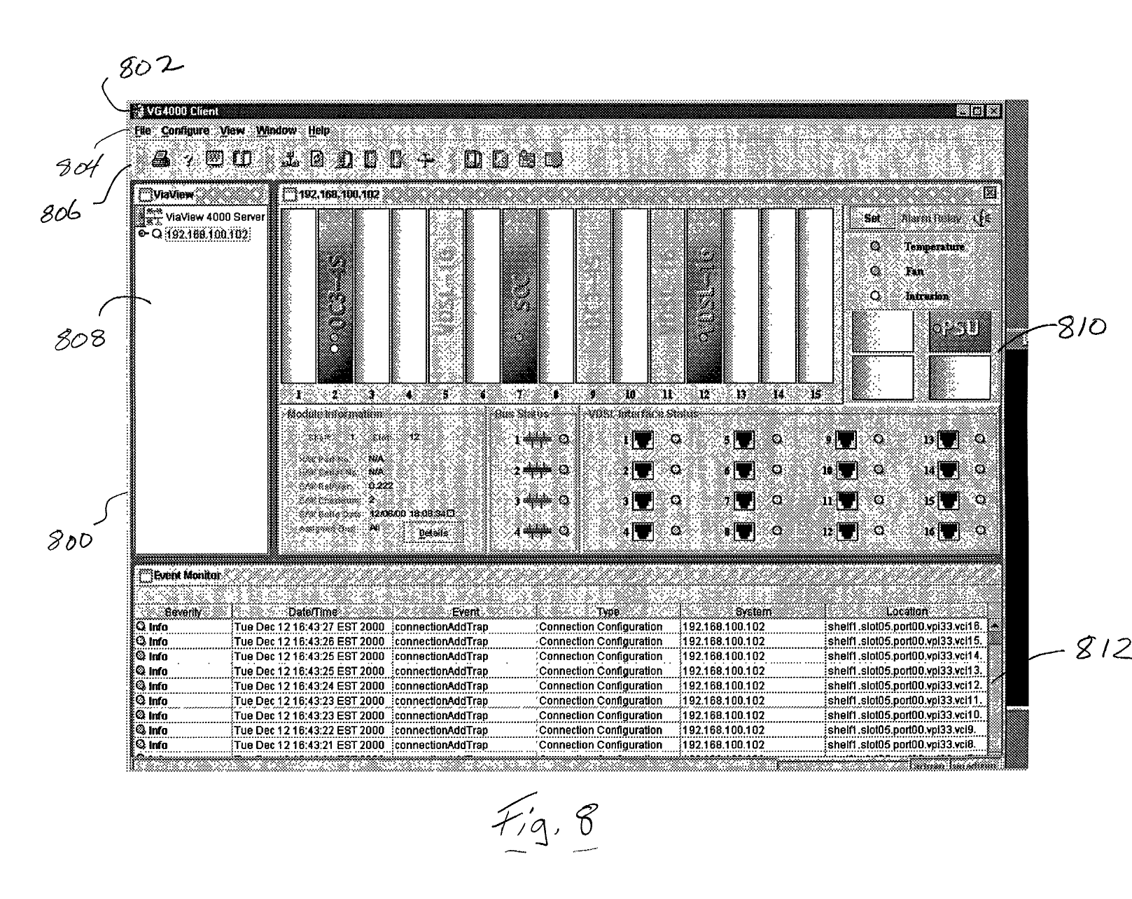

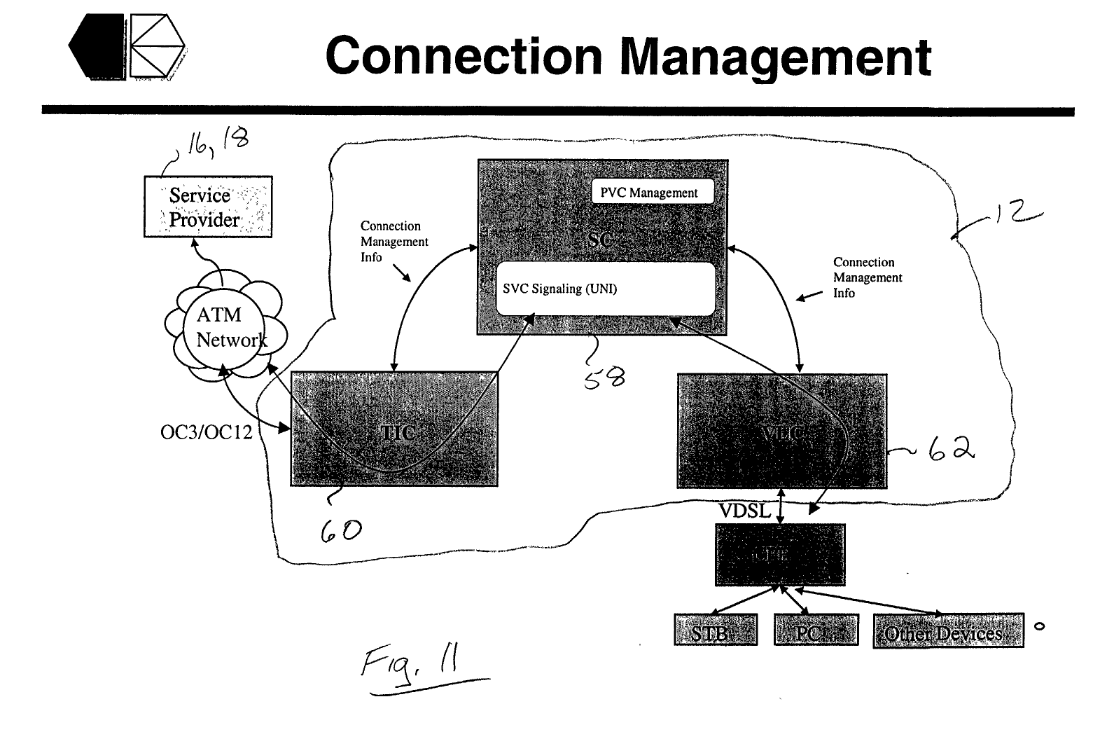

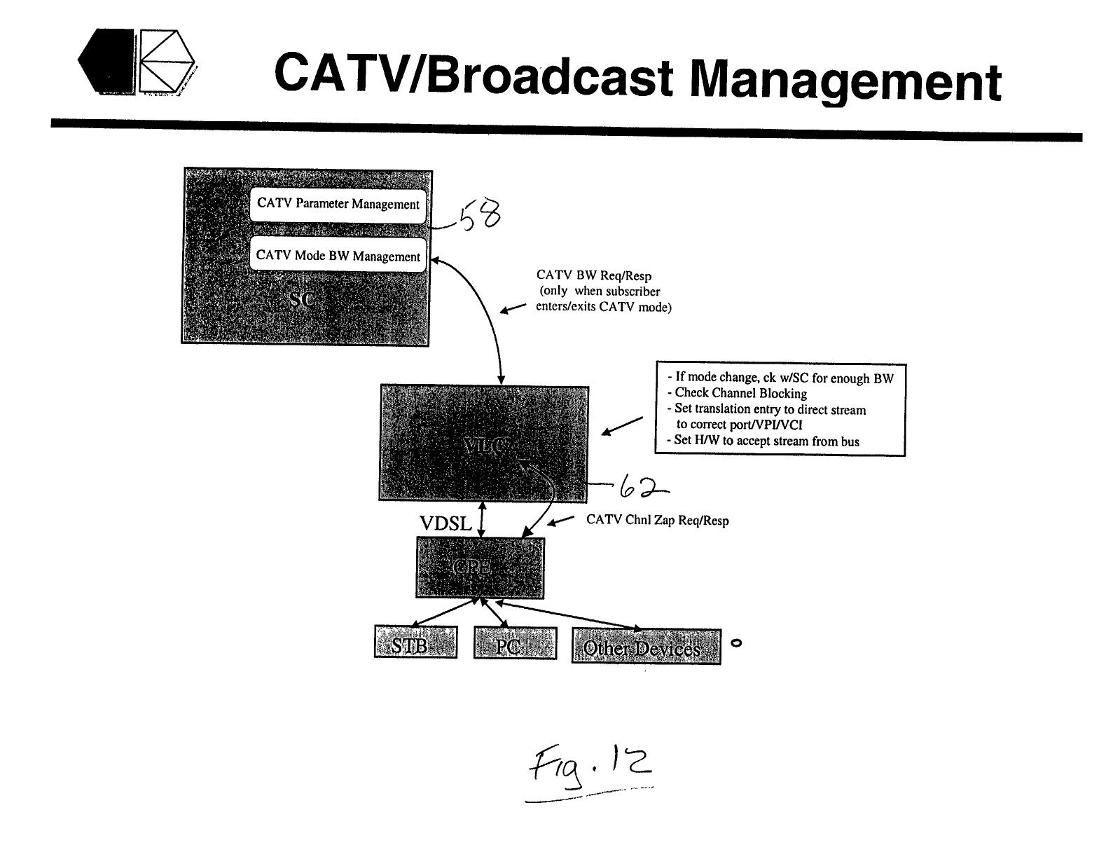

Referring now to FIG. 1, a broadband multimedia communications system 10 according to the invention includes at least one local switch 12 which is coupled to one or more servers 14, 16, 18, 20 by one or more optical links 22 to one or more ATM switches 24 as well as to the POTS network 26. A plurality of customer sites 28, 30, 32 are coupled to the local switch 12 by VDSL connections over unshielded twisted pairs 34, 36, 38 (e.g., existing POTS lines). Each customer site is provided with at least one of several different types of customer premises equipment (described below with references to FIGS. 7a-7c) which enables multiple telephones, televisions, and personal computers to be coupled to the VDSL connection so that broadband multimedia communication may be effected as described in more detail below with reference to FIGS. 11 and 12. According to the presently preferred embodiment, each local switch 12, as well as customer premise equipment (described below), is remotely configurable by a computer 40 (shown to be coupled to the ATM network 24, but which may be located anywhere coupled to the internet) as described in detail below with reference to FIGS. 8-10. In addition, each local switch 12, as well as customer premise equipment (described below) is preferably provided with means for local configuration.

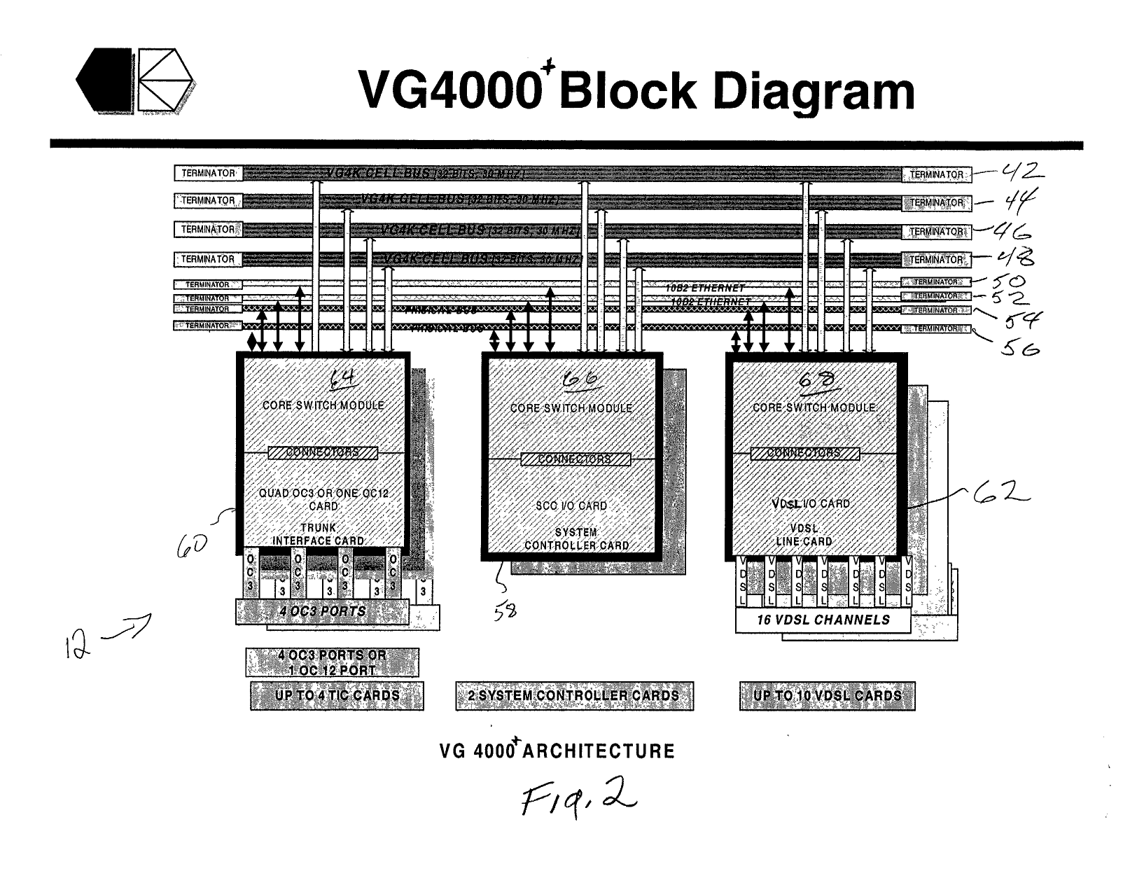

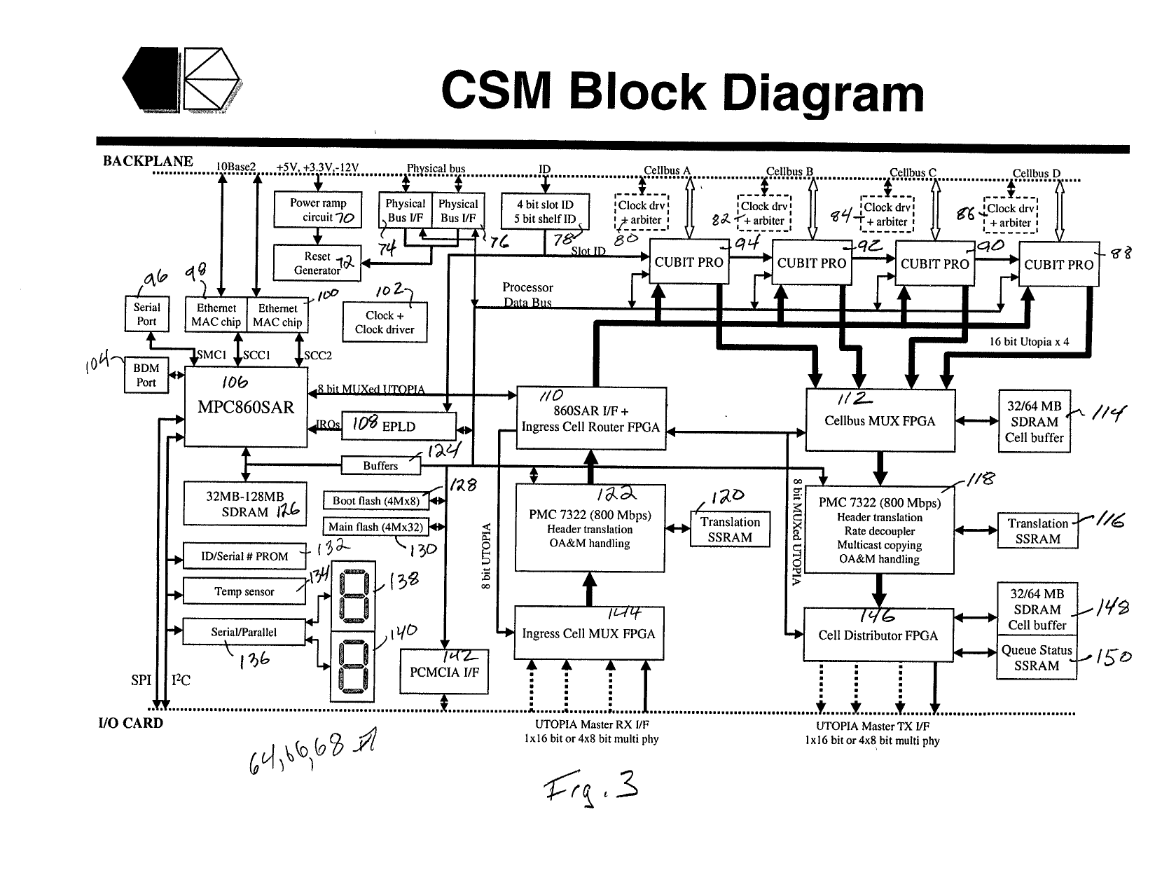

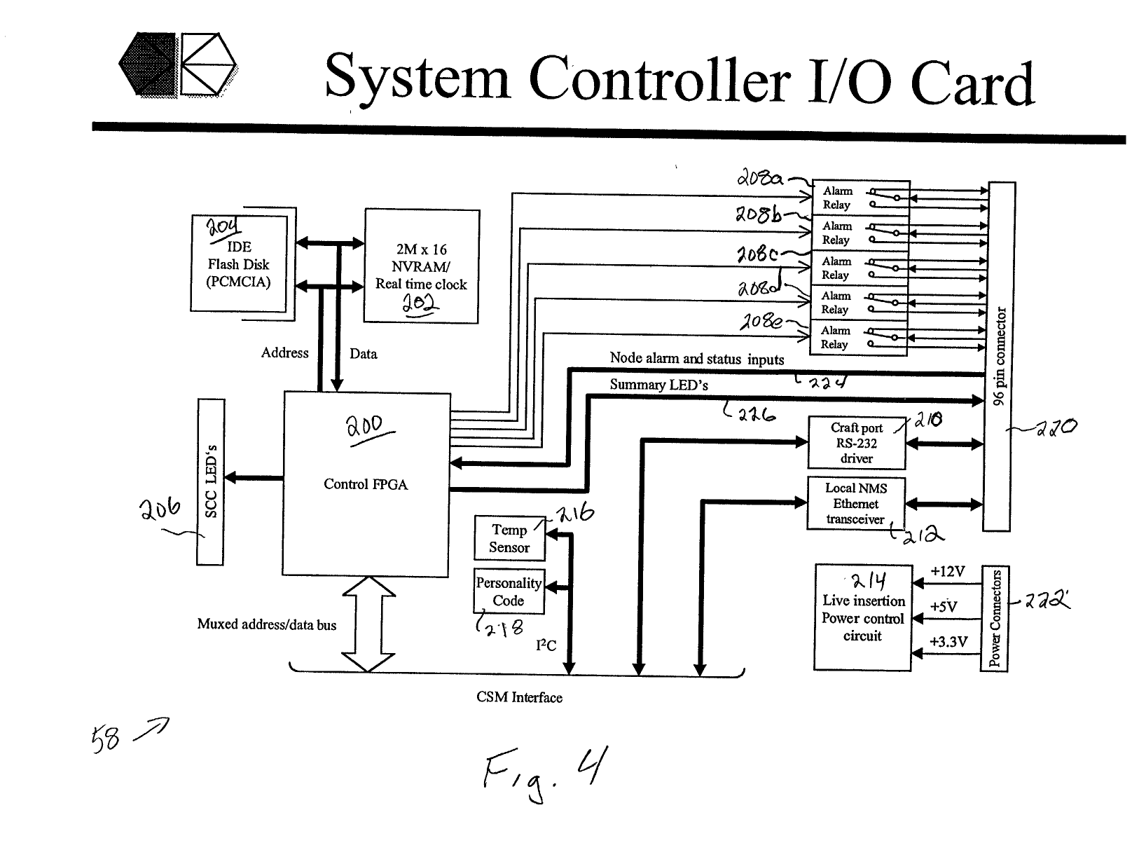

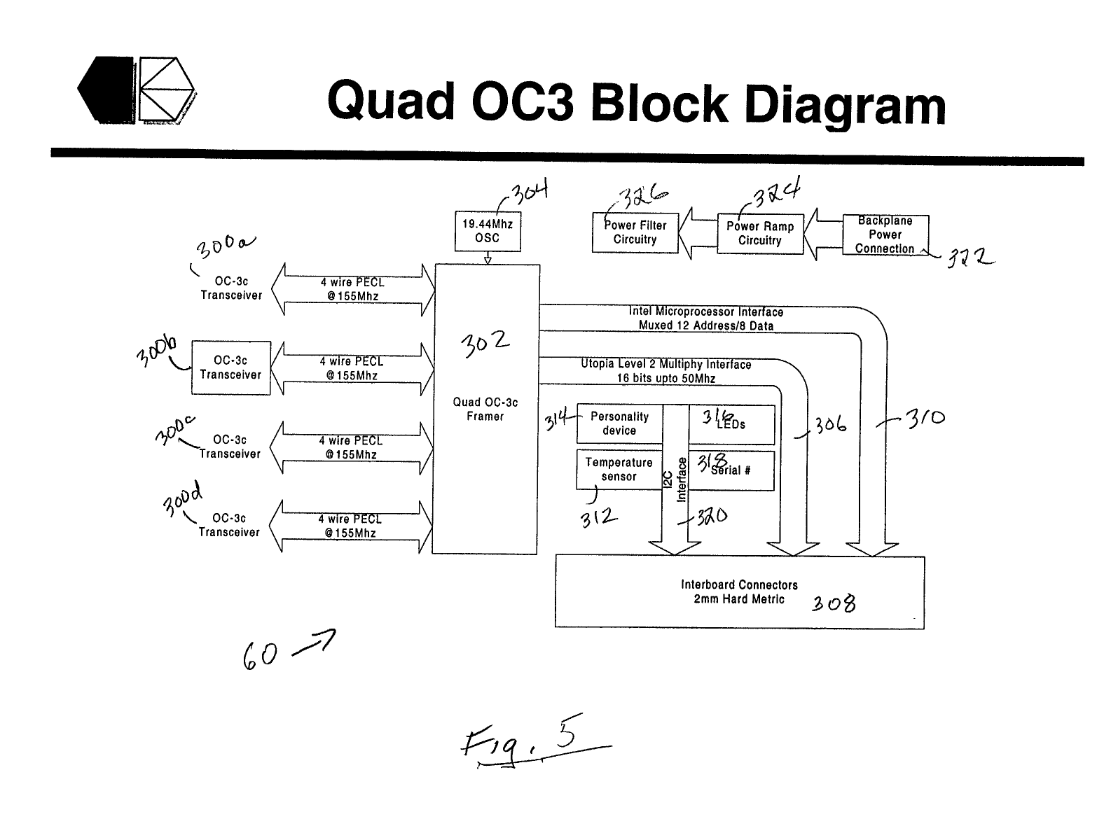

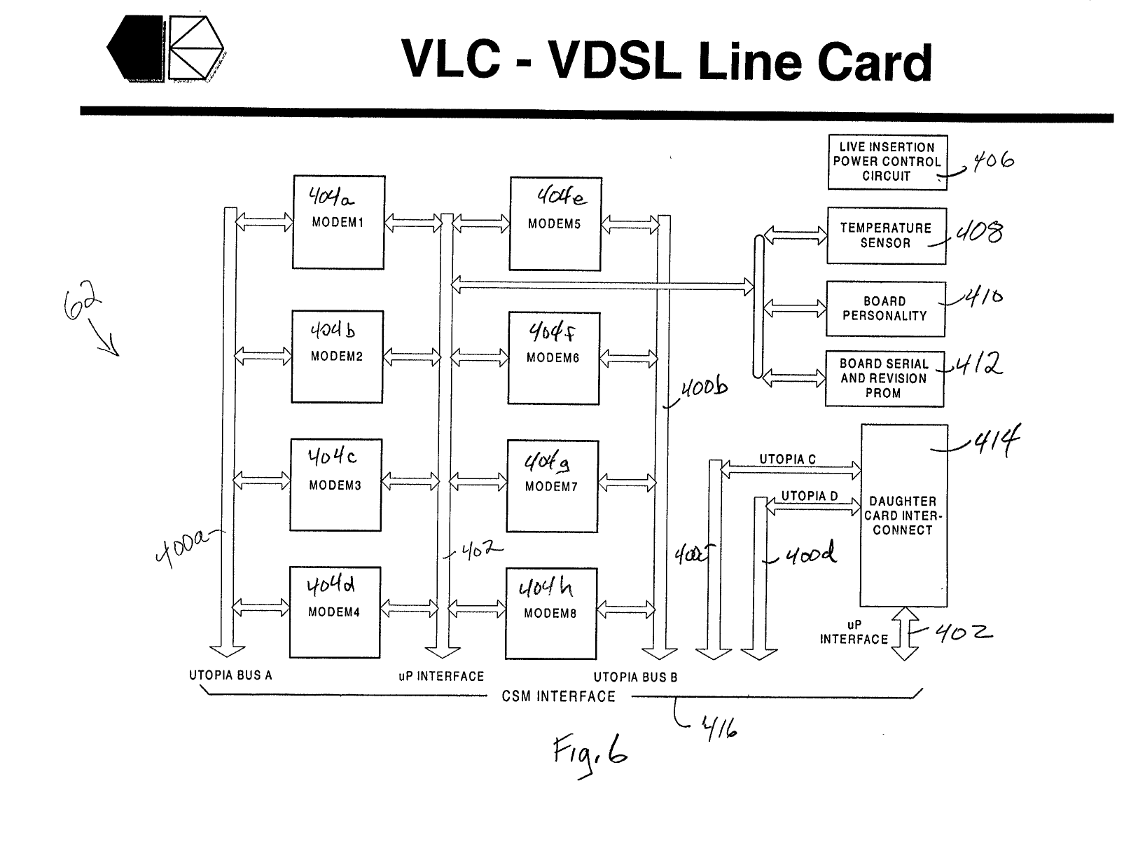

Turning now to FIG. 2, according to the preferred embodiment of the invention, the major components of the local switch 12 include four CellBus® backplanes 42, 44, 46, 48, two Ethernet LANS 50, 52, two physical buses 54, 56 and three different types of cards. The three different kinds of cards include a system controller card 58, a trunk interface card 60, and a VDSL line card 62. Each of these three types of cards uses an identical core switch module 64, 66, 68 which is described in detail below with reference to FIG. 3. The circuitry unique to the system controller card 58 is described in detail below with reference to FIG. 4. The circuitry unique to the trunk interface card 60 is described in detail below with reference to FIG. 5. The circuitry unique to the VDSL line cards is described in detail below with reference to FIG. 6.

According to the presently preferred embodiment, the local switch 12 has fifteen slots which accommodate (in subcombination) up to two system controller cards 58, up to eight trunk interface cards 60, and up to twelve VDSL line cards 62. The presently preferred embodiment utilizes three trunk interface cards, each being coupled to one CellBus® backplane and two system controller cards, each being coupled to all four CellBus® backplanes. One of the CellBus® backplanes is redundant and is only used to replace a failed CellBus® backplane. Only one system controller is active and the other is a backup in the event the active controller fails. As described in more detail below with reference to FIGS. 3 and 4, slots 7 and 8 are reserved for system controller cards which provide CellBus® clocking and arbitration. The other slots may accept either trunk interface cards or VDSL line cards. As described in detail below with reference to FIG. 6, each VDSL line card supports up to sixteen customers (“ports”). The following terminology is used elsewhere in this application when referring to scalable installations: a “node” is a group of local switches which have been “chained” together and a “shelf” is one of the local switches in the node. From the foregoing, it will be appreciated that each local switch 12 can support up to one hundred sixty customers. Due to the VDSL specification, customers may be located up to three thousand feet from a local switch 12. The local switches or nodes are preferably installed in telephone company central offices. In densely populated urban areas, a switch or a node may be located in an apartment building to service all of the apartment units. In suburban areas, if customers are too far from a central office, a switch or node may be installed in an equipment locker located closer to customers.

Turning now to FIG. 3, details of the core switch module (CSM) are seen. The CSM controls the transfer of ATM traffic between the backplanes and the card coupled to the module. Traffic flows toward the backplanes from the ingress cell MUX FPGA 144 which receives ATM cells from a UTOPIA interface having four 8-bit busses or one 16-bit bus. The cells are passed to a first header translator 122 where the ATM header is remapped according to information stored in the translation RAM 120. The cells with new headers are then passed to the ingress cell distribution router FPGA 110 which routes the cells to the appropriate Cubit Pro® chip 88, 90, 92, 94 depending for which Cellbus® backplane the cells are destined. (The Cubit Pro® chip is available from TranSwitch Corporation, Shelton, Conn.) Each Cubit Pro® chip has a multicast lookup table. Multicast cells have an 8-bit multicast ID which is used with the lookup table (on the receiving card) to determine multicast destinations for the cells (i.e. whether the cells will be accepted by the card). As described in more detail below, with reference to FIG. 12, one of the methods of the invention uses the multicast tables and IDs to avoid wasting bandwidth with regard to video streams.

Traffic flows from the backplanes through the Cubit Pro® chips 88, 90, 92, 94 to the Cellbus® MUX FPGA 112 where up to four streams are multiplexed together with the aid of a cell buffer 114. The multiplexed stream of cells flows to a second header translator 118 which remaps the headers of the multicast cells according to information in translation RAM 116. The cells are buffered by the cell distributor 146 with associated RAM 148, 150 before exiting the core switch module to a UTOPIA interface.

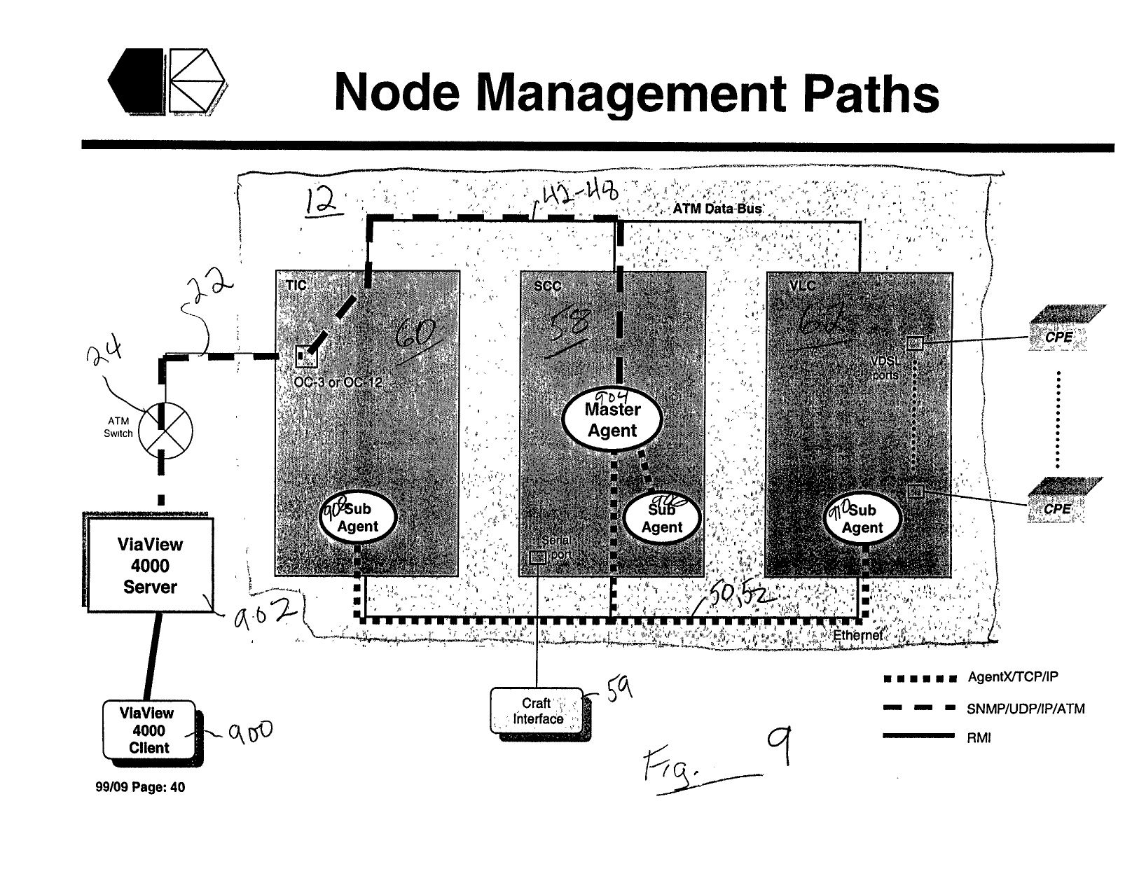

The core switch module includes other components which assist in the operations described above and which are used for other operations described below. These components include a power ramp circuit 70, reset generator 72, physical bus interfaces 74, 76, and a 4-bit slot ID/5-bit shelf ID storage 78. The physical bus interfaces 74, 76 as well as the physical bus (54, 56 in FIG. 2) are used to sense when a card is plugged into and unplugged from the backplanes. The clock driver and arbiter blocks 80, 82, 84, 86 shown in phantom lines in FIG. 3 are only used with the core switch module coupled to the system controller card. They supply the 32 MHz CellBus® clock and the arbitration logic. Due to the CellBus® specification, the clock and arbiter should be located near the center of the bus. It is for this reason that slots 7 and 8 reserved for the system controller card. The core switch module is also provided with a serial port 96 for locally configuring the switch as described in more detail below with reference to FIG. 9. Ethernet access chips 98, 100 couple the cards to the Ethernet LAN (50, 52 in FIG. 2) so that the I/O cards can communicate with each other and with the system controller card. The clock and clock driver 102 provides a 50 MHz clock for driving most of the data path.

The BDM port 104 is a debugging port. The (Motorola) MPC860SAR 106 is the main processor which controls the ingress cell router 110 directly as well as both PMC 7322 processors 118, 122 via buffers 124. The PMC 7322 is available PMC-Sierra, Burnaby, British Columbia, Canada. The EPLD (erasable programmable logic device) 108 provides interrupts to the processor 106 based on the status of the physical bus, e.g. when a card is removed from a slot. The processor 106 utilizes SD RAM 126, a boot flash RAM 128, and a main flash RAM 130. The boot flash RAM is used for booting the processor and the main flash RAM is used for nonvolatile storage of information other than boot information. An ID/Serial Number EPROM 132 stores a part number, an assembly serial number, a personality code, a MAC address, a component part number and a component serial number. The personality code indicates whether the card attached to the core switching module is a VDSL line card, a trunk interface card, or a system controller card. In the case of a line card, the personality code also indicates the number of modems (ports) on the line card, including any attached daughter card (explained below with reference to FIG. 6). In the case of a trunk interface card, the personality code indicates the bandwidth of the card. Each core switching module also includes a temperature sensor 134, preferably placed near the hottest part of the board. The processor 106 receives input from the temperature sensor and generates an alarm if the temperature crosses a threshold. Each core switching module includes a Philips PCF8575TS CHIP 136 driving two seven segment LEDs 138, 140 which indicate diagnostic codes. The processor 106 includes an I²C controller 139 and an SPI controller 141 which are used to access features of the card coupled to the core switching module. A PCMCIA interface 142 supports PCMCIA devices coupled to the card which is attached to the core switching module. See, e.g., 204 in FIG. 4.

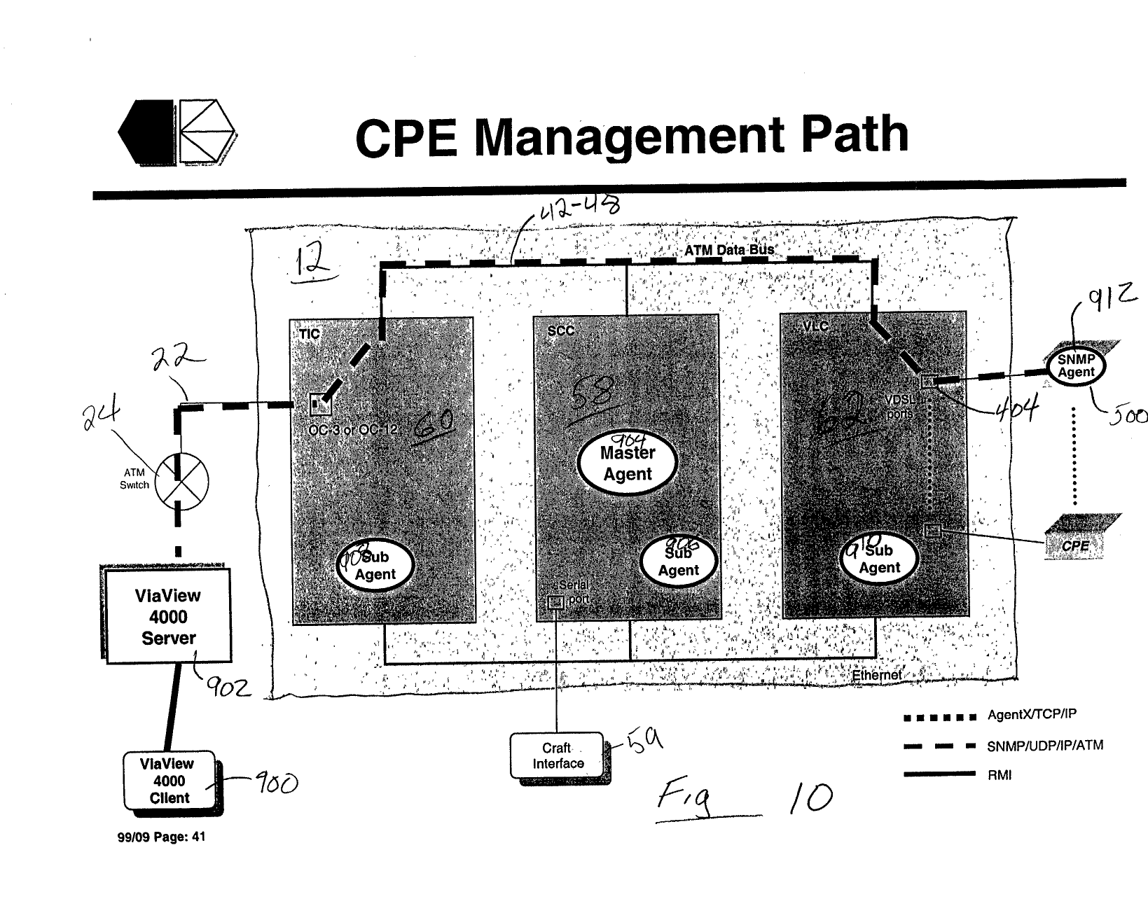

Turning now to FIG. 4, the system controller I/O card 58 is seen and includes a control FPGA 200, non-volatile RAM 202, removable flash disk storage 204, an LED controller display 206, five alarm relays 208a-208e, a craft port serial driver 210, an Ethernet transceiver 212, a power control circuit 214, a temperature sensor 216, and a personality code ROM 218. The FPGA 200 is coupled to the RAM 202, the flash disk 204, the LED display 206 and the alarm relays 208a-208e. In addition, the FPGA 200 is doubled to the core switch module (66 in FIG. 1). Further, the FPGA 200 receives node alarm and status inputs 224 from and provides summary LED control 226 to the local switch (12 in FIG. 1) via a connection 220 to the backplane. Each of the alarm relays 208a-208e is bidirectionally coupled to the local switch via the backplane connector 220. The serial driver 210 is coupled to the craft port (FIGS. 9 and 10) in the local switch which enables an on-site technician to configure and/or troubleshoot the switch and/or its components. The Ethernet transceiver 212 allows the system controller I/O card to communicate with network management software as described below. According to the presently preferred embodiment, the cards communicate via IP (internet protocol). The live insertion power control circuit 214 is coupled to the power ramp circuit (70 in FIG. 3) via power connector 222 to the backplane (FIG. 3). The circuit 214 permits “hot swapping” of cards on the backplane. The operation of the system controller I/O card, as well as the other cards, is described in detail below with reference to FIGS. 9-12.

As mentioned above, the trunk interface cards (60 in FIG. 2) may be configured in different ways to accept and support different OC connections. FIG. 5 illustrates an exemplary Quad OC-3 trunk interface card 60. The card 60 includes four OC-3c transceivers 300a-300d which are coupled to a Quad OC-3c framer driven by a 19.44 MHz clock 304. The framer 302 provides Utopia Level 2 data via the interface 306 and interboard connectors 308 to the core switch module (64 in FIG. 2). An Intel microprocessor interface 310 is also provided via interboard connectors 308 to the core switch module. The Intel interface uses fewer pins than a Motorola interface. In order to conserve pin use, the Motorola interface is converted to an Intel interface. The trunk interface card 60 also includes a temperature sensor 312, a personality ROM 314, an LED display 316, and a serial number ROM 318, each of which is coupled to the core switch module via an I²C bus interface 320 and interboard connectors 308. The I²C bus is a standard bus which is patented by Philips Semiconductors, Detroit, Mich. As mentioned above, the personality ROM includes an indication about the type of card and its configuration. In the example shown in FIG. 5, the personality ROM will indicate that the card is a trunk interface card with four OC-3 links. The trunk interface card 60 also includes a backplane power connector 322 which provides power to power ramp circuitry 324 which provides power to power filter circuitry 326. The operation of the trunk interface card, as well as the other cards, is described in detail below with reference to FIGS. 9-12.

An exemplary VDSL line card 62 is shown in FIG. 6. The line card 62 has four UTOPIA buses 400a-400d and a microprocessor interface 402. Each UTOPIA bus supports up to four VDSL modems. As shown, the line card 62 shown in FIG. 6 only supports eight modems 404a-404h. In addition to the eight modems and interfaces, the line card includes a live insertion power control circuit 406 which allows the card to be “hot swapped”. The card also includes a temperature sensor 408, a personality ROM 410, and a serial number and revision number ROM 412, each of which is coupled to the microprocessor interface 402. An additional eight modems can be added to this card via the use of a daughter card which couples to this card via a daughter card interconnect 414. Those skilled in the art will appreciate that the daughter card (not shown) will have substantially the same layout as the line card 62 but will share the same core switch module interface 416 and the same power circuit 406. The operation of the VDSL line card, as well as the other cards, is described in detail below with reference to FIGS. 9-12.

The foregoing discussion all involves the portions of the invention outside of the customer's premises. According to the invention, various customer premises apparatus are provided by the invention and examples are described below with reference to FIGS. 7a-c.

FIG. 7a illustrates equipment 500 for providing high speed internet access and for linking to other customer premises equipment described below with reference to FIG. 7c, for example. The equipment 500 includes a power module 502 which requires coupling to the customer's power mains and a VDSL connector 504 for coupling to the twisted pair which leads to the corresponding VDSL modem at the local switch. The VDSL connector 504 supplies a connection to a POTS/ISDN splitter 506 which splits out the POTS/ISDN lifeline 508, and a connection to a VDSL modem 510. The VDSL modem 510 is coupled by an I²C bus to a Helium chip 514 (available from Virata Corporation, Santa Clara, CA) and by a UTOPIA Level 2 bus 516 to both the Helium chip 514 and a CPLD (Complex Programmable Logic Device) 518. The Helium chip 514 has a peripheral interface 520, a protocol processor 522, SDRAM interface 524, a Utopia interface 526, a GPIO (general purpose input/output) 528, an Ethernet interface 530, and a network processor 532. The peripheral interface 520 is coupled to the CPLD 518 and the protocol processor 522. The SDRAM interface 524 is coupled to the protocol processor 522, the network processor 532, and to an offchip SDRAM 544. The Utopia interface 526 is coupled to the Utopia bus 516 and the network processor 532. The GPIO 528 is coupled to the I²C bus 512, the network processor 532, a terminal jack 534 for local configuration, an LED display 536, and a boot PROM 548. The Ethernet interface 530 is coupled to the network processor 532 and an Ethernet jack 538. The Helium chip also provides a JTAG interface 542 which is coupled to a JTAG jack 540. As shown in FIG. 7a, the CPLD 518 provides an ATM-25 interface 550 for coupling to other customer premises devices such as the set-top box shown in FIG. 7c. The CPLD is provided with flash RAM 546 and an LED display 552. In most instances, customers will couple a PC (not shown) or an Ethernet LAN to the Ethernet Jack 538 to obtain high speed internet access according to the invention. The terminal jack and JTAG interface are used for configuration and debugging, respectively.

Referring now to FIGS. 7a, 6, 3, 2, and 5, when a PC is coupled to the Ethernet jack 538 (FIG. 7a), data (typically in the form of TCP/IP) flows bidirectionally through the Ethernet interface 530 to the network processor 532 where TCP/IP data is packed into and extracted from ATM cells. The ATM cells flow through the Utopia interface 526, Utopia level 2 516, the modem 510, and the VDSL interface 504 to the appropriate modem 404 (FIG. 6) on the appropriate VDSL line card 62. The cells are routed via the Utopia bus 400 to/from the Cell Mux 144/Cell Distributor 146 on the core switch module 68 (FIG. 3) associated with VDSL line card 62. The ATM cells containing TCP/IP packets flow together with the other ATM cells containing video, telephony data, etc. through an appropriate CubitPro 88, 90, 92, 94, to/from the appropriate CellBus bus 42, 44, 46, 48 (FIG. 2) to/from an appropriate trunk interface card 60 (FIG. 5). The trunk interface card receives cells from and transmits cells to the CellBus buses via the core switch module 64 (FIG. 3) to which it is attached via the Utopia interface 306 (FIG. 5). The cells are directed to/from an appropriate OC3c transceiver 300 via the Quad OC-3c framer 302. According to the preferred embodiment, the ATM connection between the trunk interface card and the Ethernet interface 530 (FIG. 7a) is provisioned as a PVC and is therefore “always connected”. It will be appreciated that the POTS line 508 is split off to the telco CO either at the local switch or at some point downstream of the switch.

FIG. 7b illustrates equipment 600 which is similar to equipment 500 with similar reference numerals, increased by 100, referring to similar parts. The equipment 600 differs from the equipment 500 by the inclusion of a DSP 654, a serial link interface card 656, and POTS emulators 658-664. The DSP 654 is coupled to the protocol processor 622 on the Helium chip 614 and to the interface card 656. It provides an analog to digital and digital to analog interface between the protocol processor 622 and the interface card 656. The POTS emulators 658-664 provide all of the analog signals of a regular POTS line so that regular POTS devices such as telephones, fax machines, modems, etc. can be coupled to the equipment 600. The DSP 654, converts analog signals from the POTS emulators to digital signals for use by the protocol processor 622 and converts digital signals from the protocol processor 622 to analog signals for use by the POTS emulators 658-664. The equipment 600 shown in FIG. 7b provides up to four additional POTS lines via the POTS emulators and the DSP.

Referring now to FIGS. 7b, 6, 3, 2, and 5, when a telephone (or similar device, e.g. fax machine) is coupled to one of the derived POTS interfaces 658, 660, 662, 664, the interface provides a POTS emulation including ringing signals and dialtone. Analog voice signals from/to the POTS interfaces are muxed/demuxed by the four port SLIC 656 and converted from/to digital voice signals by the DSP 654. The digital signals are processed by the protocol processor 622 and passed from/to the SDRAM interface 624. The network processor 632 extracts digital voice data from ATM cells and places the data in the SDRAM 624. It also takes digital voice data from the SDRAM 624 and packs it into ATM cells. ATM cells containing digital voice data pass through the Utopia interface 626, Utopia level 2 616, the modem 610, and the VDSL interface 604 to the appropriate modem 404 (FIG. 6) on the appropriate VDSL line card 62. The cells are routed via the Utopia bus 400 to/from the Cell Mux 144/Cell Distributor 146 on the core switch module 68 (FIG. 3) associated with VDSL line card 62. The ATM cells containing digital voice signals flow together with the other ATM cells containing video, TCP/IP packets, etc. through an appropriate CubitPro 88, 90, 92, 94, to/from the appropriate CellBus bus 42, 44, 46, 48 (FIG. 2) to/from an appropriate trunk interface card 60 (FIG. 5). The trunk interface card receives cells from and transmits cells to the CellBus buses via the core switch module 64 (FIG. 3) to which it is attached via the Utopia interface 306 (FIG. 5). The cells are directed to/from an appropriate OC3c transceiver 300 via the Quad OC-3c framer 302. According to the preferred embodiment, the ATM connections between the trunk interface card and the POTS interfaces 658, 660, 662, 664 (FIG. 7b) are set up when needed as relatively low priority connections when a customer takes a telephone off hook and dials a number and when incoming ATM cells include voice data addressed to one of the POTS interfaces.

FIG. 7c illustrates a digital set-top box 700 suitable for use with either the equipment 500 shown in FIG. 7a or the equipment 600 shown in FIG. 7b. The set-top box 700 generally includes an ATM-25 interface 102 for coupling with the ATM-25 interface 550 or 650 in equipment 500 or 600 respectively. The ATM-25 interface 702 is coupled to a PCI Bus 704. The components above the PCI bus in FIG. 7c illustrate the components for receiving MPEG video signals and converting them into signals which can be displayed on a television set. An MPEG decoder 706 is coupled to the PCI bus 704. The MPEG decoder 706 is provided with associated SDRAM 708 and provides a digital video output signal to an SVGA video card 710 having associated SGRAM 712. The digital signal from the SVGA card 710 is converted to an analog signal by a digital to analog converter 714 and is converted into an NTSC composite video signal by an NTSC encoder 716. A composite video output is provided via an RCA jack 718 for coupling the composite video input of a VCR or TV/monitor. The MPEG decoder 706 delivers the audio portion of the signal to an audio decoder 720 which provides a digital audio signal to a digital to analog converter 722. The DAC 722 provides an analog audio output to an RCA jack 724 for coupling to the audio input of a VCR or TV/monitor. Though not shown in FIG. 7c, the RCA jack 724 is preferably two jacks, a left channel jack and a right channel jack, providing stereo analog audio channels. For television receivers which do not have composite video and analog audio inputs, an RF modulator 726 is provided. The RF converter receives composite video from the NTSC encoder 716 and analog audio from the DAC 722 and provides an RF output (typically switchable to either VHF channel 3 or 4) to an CATV coaxial cable connector.

The components shown below the PCI bus in FIG. 7c are used to select channels and otherwise interact with the set-top box. A PCI bridge 730 couples a CPU 732 and associate SDRAM 734 to the PCI bus 704. An ISA bridge 736 couples the PCI Bus 704 to an ISA bus 738, an IDE interface 740 and a USB interface 742. An I/O processor 744 and a v.90 modem 746 are coupled to the ISA bus 738. The I/O processor 744 is coupled to a BIOS 748, an IR port 750, and a parallel port 752. Basic operation of the set-top box 700 is via an infrared remote (not shown) which signals the set-top box via the IR port 750. The IDE interface 740, USB interface 742, and parallel port 752 are provided for coupling the set-top box to other devices such as disk drives, keyboards, video games, digital video recorders, etc. The modem 746 is provided with an RJ-11 jack (not shown) for coupling to a phone line and is used for services which require a dial up connection, such as some directory and VCR programming services.

As mentioned above with reference to FIG. 1, the local switch and the customer premises equipment may be accessed remotely for configuration, status monitoring, testing and debugging, etc. Accordingly, as will be described as follows with reference to FIGS. 8-10, each device is assigned a unique IP address and is provided with an SNMP agent/subagent. A computer (e.g. 40 in FIG. 1) provided with the configuration software of the invention addresses individual local switches as illustrated in FIG. 8, communicates with the local switch as illustrated in FIG. 9, and communicates with the individual customer premises units attached to the local switch as illustrated in FIG. 10. The connection of the computer with the local switches and customer premises equipment may be remote via the internet or the ATM network or may be local via the Ethernet connections provided at each device.

Referring now to FIG. 8, the management software of the invention is preferably provided with a graphical user interface (GUI) 800. The GUI 800 includes window headers 802, 804, a tool bar 806, a network map view 808, a device status/configuration view 810, and an event monitor view 812. The window headers 802, 804 includes standard buttons and menus familiar to all GUIs. The tool bar 806 includes small icons (buttons) for printing reports, accessing help, zooming in on a display, as well as other buttons for accessing features specific to the software of the invention. The network map view 808 illustrates all of the devices that are accessible to the software as well as the hierarchical path to the device currently being accessed by the software. As shown in FIG. 8, the device being accessed has the network address 192.168.100.102 and the contents of the device status/configuration view 810 indicate that the device is a local switch. The device status/configuration view 810 illustrates the various aspects of the device which are configurable and provides some status information.

As shown in FIG. 8, the device status/configuration view 810 shows a local switch which has two trunk interface cards, one in slot 2 and one in slot 9, one system controller card in slot seven, and three VDSL line cards in slots 5, 11, and 12. All other slots are empty. The status/configuration view 810 also illustrates (in the upper right portion) three alarms: temperature, fan, and intrusion as well as power supply unit (PSU) status. The temperature alarm indicates whether the ambient temperature is too high or too low for the equipment to function properly. The fan alarm indicates when the cooling fan malfunctions. The intrusion alarm indicates whether someone without authorization has attempted to tamper with the equipment. The PSU status indicates a power supply failure. The lower portion of the status/configuration view illustrates information about a selected one of the cards displayed in the upper portion of the view. As shown in FIG. 8, the card in shelf one, slot twelve has been selected. FIG. 8 illustrates that sixteen modems reside on the VDSL line card. Each modem is illustrated as an RJ-45 jack icon. A lamp icon next to each RJ-45 jack icon indicates if there is an alarm condition with respect to the respective modem. The status of the four buses coupled to the selected VDSL line card is also indicated to the left of the modem icons.

The event monitor view 812 includes a table (log) of information about noteworthy events in the network (not just the device selected in view 808). For each event, there is an indication of severity, date and time of the event, name of the event, type of event, IP address of the device affected, and the shelf and slot location of the affected card, where appropriate.

Using software with the graphical interface shown in FIG. 8, it is possible to configure a local switch as illustrated in FIG. 9. As shown in FIG. 9, client software 900, running on server 902 configures local switch 12 via the ATM switch 24 and the fiber optic link 22 using SNMP commands. As mentioned above, client software may be run on a computer which is locally coupled to the switch 12 via an Ethernet connection (212 in FIG. 4). In particular, SNMP commands are sent through the trunk interface card 60 via the backplane 42-48 to a master SNMP agent 904 in the system controller card 58 which directs commands to sub-agents 906, 908, 910 in a system controller card 58, trunk interface cards 60, and VDSL line cards 62, respectively. In this manner, each system controller card 58, trunk interface card 60, and VDSL line card 62 can be remotely configured, monitored, tested, etc. As shown in FIG. 9, information is passed between the server 902 and the master agent 904 via SNMP/UDP/IP/ATM and between the master agent and sub-agents via AgentX/TCP/IP. As illustrated in FIGS. 9 and 10, the client 900 may communicate with the server 902 remotely using the Java communication protocol RMI (remote method invocation). Information flowing between the master agent 904 and sub-agents 908, 910 on other cards, flows over the Ethernet LAN 50, 52. The local switch 12 can also be configured via a craft interface 59 at the switch. The craft interface permits a technician to connect a portable computer to the switch via an RS-232 serial connection for configuration, testing, and trouble shooting with a command line interface.

FIG. 10 illustrates how SNMP commands from the client software 900 are sent to an SNMP agent 912 in a customer premises device 500. In particular, commands from the server 902 flow through the ATM switch 24 and the fiber optic trunk 22 to the trunk interface card 60 in the local switch 12. The trunk interface card 60 passes the commands via the backplane 42-48 to the appropriate VDSL line card 62 and the appropriate port 404 on the card to the SNMP agent 912 in customer premises equipment 500. According to the presently preferred embodiment, the address of customer premises equipment is given as a VPI/VCI from the VDSL line card. The network management software addresses the customer premises equipment with an IP address.

Referring now to FIG. 11, it should be noted that according to a preferred embodiment of the invention all broadcast television channels are brought to the local switch 12 via PVC (permanent virtual circuit) connections to the trunk interface cards 60 and thus all channels are always available simultaneously to the local switch for transport to subscribers via the VDSL line cards 62. Other television streams, e.g. video on demand, are brought to the local switch via SVC (switch virtual call) connections or PVC connections. All video streams from the local switch to the subscribers are set up using the dynamic channel zapping protocol described below. As mentioned above, according to the presently preferred embodiment up to four different simultaneous video streams may be provided to each subscriber. The number four was chosen based on demographical information regarding the average number of television receivers per household. Those skilled in the art will appreciate, however, that more or fewer simultaneous video streams may be provided depending on the allocation of bandwidth between the customer premises and the local switch.

FIG. 11 generally illustrates that the system controller 58 maintains PVC management information in non-volatile form (on a flash disk). The PVC management information is provided by the network management software or via the craft interface. When a trunk interface card 60 or a VDSL line card 62 is added to the system, the system controller card 58 sends connection management information (all of the information needed to set up and maintain PVCs) to these cards. The cards store the connection management information in memory used by the ATM translation chips so that ATM cells flow properly with proper cell translation and tagging. If PVCs are added or deleted (new channels added, old channels removed) the PVC management information is altered in the system controller and the system controller automatically updates the trunk interface cards and the VDSL line cards. SVCs are established via ATM signalling between the customer premises equipment and the system controller 58 via a pass through connection (VC) in the line card 62 and between the system controller 58 and the ATM network switch (24 in FIG. 1) via a pass through (VC) connection in the trunk interface card 60. Setting up and tearing down SVCs is performed by the system controller through connection management messages to the affected cards.

Switching of streaming video connections between the local switch and the subscribers is handled by the VDSL line cards 62 as described in more detail below with regard to FIG. 12. In the case of a non-broadcast (i.e. unicast) video stream, the switch controller 58 sets up an SVC connection between the local switch and a video service provider, e.g. 16, 18.

Turning now to FIG. 12 and with reference to FIGS. 7a and 7c, when a customer selects a channel with the set top box 700, the customer premises equipment 500 requests a video stream by designating the channel (e.g. 1-200) and designating a VPI/VCI (virtual path identifier/virtual circuit identifier) to be used by the VDSL line card (62 in FIGS. 2 and 6) to send the selected stream to the customer premises equipment 500 which passes it to the set top box 700 via the ATM-25 interface (550 and 702). The line card 62 (FIG. 6) receives the channel request, in the form of one or more ATM cells via a modem 404 and passes the cell(s) via the UTOPIA bus 400 to its associated core switch module 68 (FIGS. 2 and 3). The core switch module 68 receives the cell(s) via the ingress cell mux 144 which passes it to the PMC 7322 122 for header translation. The ingress cell router 110 passes the cell(s) to the processor 106 which checks a channel blocking map in SDRAM 126 to determine whether the customer is entitled to receive the selected channel.

If the subscriber is not already in “broadcast mode”, i.e. if this is the first channel selection for the subscriber, the line card 62 requests permission from the system controller 58 via the Ethernet LAN 50, 52 to allow broadcasting to the designated subscriber. Using the control FPGA 200 (FIG. 4) and associated memory 202, 204, the system controller 58 determines whether the viewer calling for broadcast mode is entitled to enter broadcast mode. If the system controller grants permission, the line card examines the bit maps in the CubitPro chips 88, 90, 92, 94 to determine whether the selected video stream is already streaming through the line card to another viewer (whether the same or a different customer) coupled to this line card.

If the stream is not already available on the same VDSL line card, the bitmap in the appropriate CubitPro chip is changed to enable the stream to be received from the trunk interface card 60 via one of the CellBus buses 42, 44, 46, 48; and an entry is added to the egress translation table 116 to direct the stream properly to the correct VDSL port 404 and the originally designated VPI/VCI (i.e. the set top box from which the channel request originated). If the stream is already available on the card, an entry is added to the egress translation table 116 to allow for duplication of the stream and routing to the viewer who requested it.

The protocol for managing channel changes and video streams between the customer premises equipment and the VDSL line card is based upon the DSM-CC (digital storage media command and control) SDB-CCP (switched digital broadcast channel change protocol) as adapted to the DAVIC (Digital Audio Visual Council) environment. The usage and the protocol stack differ, however. In the DAVIC environment, the CCP was intended to be used between the customer premises device and the video service provider. The goal of the SDP-CCP was to conserve network bandwidth by carrying over the network only those video streams which are actually being viewed. According to the present invention, all available broadcast channels are carried on the network regardless of whether any are actually being viewed by a customer. Channels are selected for viewing by a customer by sending a message to the VDSL line card in the local switch rather than by sending a message over the network to the video service provider. This method of the present invention permits the combination of high QOS broadband internet service, high QOS voice telephony, and a broad selection of video streams all over the same medium.

There have been described and illustrated herein several embodiments of methods and apparatus for broadband multimedia telecommunications. While particular embodiments of the invention have been described, it is not intended that the invention be limited thereto, as it is intended that the invention be as broad in scope as the art will allow and that the specification be read likewise. Thus, while particular “off-the-shelf” components have been disclosed, it will be appreciated that other components could be utilized. Also, while particular communications protocols have been shown, it will be recognized that other protocols could be used with similar results obtained. Moreover, while particular configurations have been disclosed in reference to alarms and other status information, it will be appreciated that other configurations could be used as well. Furthermore, while the local switch of the invention has been disclosed as having a certain bandwidth, it will be understood that bandwidth may be expanded depending on the application. It will therefore be appreciated by those skilled in the art that yet other modifications could be made to the provided invention without deviating from its spirit and scope as so claimed.

1. A broadband multimedia telecommunications system, comprising:
a) a local switch having a trunk interface coupled to an optical network and a line interface coupled to a digital subscriber line, said local switch receiving a first plurality of audio/video channels via the optical network; and
b) customer premises equipment coupled to the digital subscriber line and to an audio/video output device, said customer premises equipment including channel selection means for selecting a channel from said first plurality of channels for transmission from said local switch to said customer premises equipment, wherein
said channel selection means includes means for sending a message to said local switch, said message identifying a selected channel,
said local switch includes message receiving means for receiving said message and channel transmission means for transmitting the selected channel to said customer premises equipment, and
channels not selected by said channel selection means are not transmitted to said customer premises equipment.

2. A system according to claim 1, wherein:
said channel transmission means is capable of transmitting up to four different channels simultaneously to said customer premises equipment.

3. A system according to claim 1, wherein:
said trunk interface accommodates up to four OC-3 ports or one OC-12 port.

4. A system according to claim 3, wherein:
said line interface accommodates up to one hundred sixty digital subscriber lines.

5. A system according to claim 1, wherein:
said local switch further includes a system controller coupled to said trunk interface and said line interface,
said line interface includes a second plurality of line cards, each line card being coupled to a third plurality of digital subscriber lines,
said customer premises equipment includes a third plurality of customer premises equipment, one coupled to each digital subscriber line,
said message receiving means includes a second plurality of message receiving means, one on each line card,
said channel transmission means includes a second plurality of channel transmission means, one on each line card, and
said system controller is responsive to said line cards for routing one or more of said first plurality of channels to said line cards.

6. A system according to claim 5, wherein:
when a message is received by one of said message receiving means on one of said line cards from one of said customer premises equipment, the channel transmission means on the same line card determines whether the channel selected by the message is already being transmitted to another customer premises equipment coupled to the same line card,
if the channel selected by the message is already being transmitted to another customer premises equipment coupled to the same line card said channel transmission means duplicates the channel selected by the message for transmission to the one of said customer premises equipment, and
if the channel selected by the message is not already being transmitted to another customer premises equipment coupled to the same line card the line card causes the channel selected by the message to be routed to the line card.

7. A system according to claim 1, wherein:
the optical network is coupled to the internet,
said customer premises equipment includes PC coupling means for coupling it to a personal computer, and
the digital subscriber line carries internet data traffic.

8. A system according to claim 7, wherein:
the digital subscriber line is coupled to a POTS line, and
said customer premises equipment includes means for splitting out the POTS line.

9. A system according to claim 7, wherein:
the digital subscriber line carries digital voice telephony, and
said customer premises equipment includes telephone coupling means for coupling it to a telephone set.

10. A system according to claim 1, wherein:
said local switch and said customer premises equipment are remotely configurable via SNMP commands.

11. A method for broadband multimedia telecommunications, comprising:
a) coupling a local switch to an optical network and to a digital subscriber line, the optical network carrying a first plurality of audio/video channels;
b) coupling customer premises equipment to the digital subscriber line and to an audio/video output device, the customer premises equipment including channel selection means for selecting a channel from the first plurality of channels for transmission from the local switch to the customer premises equipment;
c) sending a message from the channel selection means to the local switch identifying a selected channel;
d) receiving the message at the local switch; and
e) transmitting the selected channel to the customer premises equipment.

12. A method according to claim 11, wherein:
said step of transmitting includes transmitting up to four different channels simultaneously to said customer premises equipment.

13. A method according to claim 11, wherein:
said step of coupling the local switch to an optical network includes coupling it to up to four OC-3 ports or one OC-12 port.

14. A method according to claim 13, wherein:
said step of coupling the local switch to a digital subscriber line includes coupling it to up to one hundred sixty digital subscriber lines.

15. A method according to claim 11, wherein:
said step of coupling the local switch to a digital subscriber line includes coupling it to a plurality of digital subscriber lines via a single line card,
said step of coupling customer premises equipment to the digital subscriber line includes coupling customer premises equipment to each of the plurality of digital subscriber lines.

16. A method according to claim 15, wherein:
said step of transmitting the selected channel to the customer premises equipment includes determining whether the channel selected by the message is already being transmitted to another customer premises equipment coupled to the same line card,
if the channel selected by the message is already being transmitted to another customer premises equipment coupled to the same line card, duplicating the channel selected by the message for transmission to the customer premises equipment.

17. A method according to claim 11, further comprising:
f) coupling the optical network to the internet; and
g) coupling the customer premises equipment to a personal computer.

18. A method according to claim 17, further comprising:
h) coupling the digital subscriber line to a POTS line, and
i) splitting out the POTS line at the customer premises equipment.

19. A method according to claim 17, further comprising:
h) coupling the customer premises equipment to a telephone set.

20. A method according to claim 11, further comprising:
f) configuring the local switch and the customer premises equipment remotely via SNMP commands.
